(19) United States
(12) Patent Application Publication
(10) Pub. No.: US 2026/0224337 A1
(43) Pub. Date: Aug. 6, 2026

(54) METHOD AND SYSTEM FOR AUTOMATIC IDENTIFICATION OF A DENTAL IMPLANT POSITION ON A BONE

(71) Applicant: The University of Hong Kong, Pokfula (CN)

(72) Inventors: Ankit Nayak, Sai Ying Pun (CN); Ming Yan Cheung, Sai Ying Pun (CN); Jingya Pu, Sai Ying Pun (CN); Yuxiong Su, Sai Ying Pun (CN)

(21) Appl. No.: 19/436,276

(22) Filed: Dec. 30, 2025

Related U.S. Application Data
(60) Provisional application No. 63/754,065, filed on Feb. 5, 2025.

(51) Int. Cl. A61C 8/00; A61C 13/00

(52) U.S. Cl. CPC A61C 8/0089; A61C 13/0004; A61C 13/0013

(57) ABSTRACT

A computer-implemented method for automatic identification of a dental implant position in a bone including the steps of receiving a dental implant parameter, generating a digital bone model of the bone, wherein the bone is a fibula, identifying an anterior aspect of the fibula, determining an implant position in the fibula.

### TECHNICAL FIELD

The present disclosure relates to a method and system for automatic identification of a dental implant position on a bone. The present disclosure relates to a system and method to facilitate dental implant placement in a fibula bone or other large bone.

### BACKGROUND

Defects of maxilla and mandible as a result of tumour resection, trauma, bony necrosis after radiation or anti-resorptive drugs often leads to significant aesthetic and functional deficits.

Among the different types of osseous fibula free flaps (FFF) remains the workhorse for jaw reconstruction due to its high volume of bone stock, a long vascular pedicle, bi-cortical implant engagement and great versatility with the option for multiple osteotomies, skin paddles and muscle bulk to suit the complex jaw and soft tissue defects. FFF reconstruction with simultaneous dental implant placement has become a common approach for the functional reconstruction of jaw defects following resection of benign or malignant tumours, allowing the rehabilitation of occlusion, chewing, swallowing, speech and aesthetics.

Conventional freehand mandibular reconstruction can be challenging and time-consuming as it greatly relies on the surgeon's experiences with ‘trial and error’ during the operation. Positioning of fibula segments using the conventional approach could make dental implant placement technically challenging and, in some instances, not possible.

Apart from explicit surgical planning and execution, successful functional reconstruction of jaw defects requires a thorough understanding of fibula morphology. The size of the selected implant depends on the height and width of available bone, however, determining the ideal implant position at fibula segments could be difficult as its cross-sectional shape and dimension varies along its length. Therefore, precise evaluation of bone dimensions and morphology are important for the precise pre-operative planning of simultaneous dental implant placement.

Pre-operative analysis of computed tomography (CT) of the lower limbs and jaws allows a better understanding of the morphology, hence allowing the fibula segments to be placed in a way that mimics the shape of the native jaw as much as possible during virtual surgical planning (VSP) to maximise the aesthetic and functional outcomes. In the case of fibula implant planning, the process of determining the appropriate implant position could be tedious as it often required ‘trial and error’ to ensure good angulation of dental implants, bi-cortical engagement, and enough bony collar over the entire implant without any thread exposure, thereby improving its stability and survival.

### SUMMARY

The present disclosure relates to a solution to determine the optimal position of a dental implant in a bone, in particular in a fibula. The method and system described herein provide an improved solution for identification of optimal dental implant position in a fibula free flap or provide the public with a useful alternative. The method and system for automatic identification of a dental implant in a fibula may also allow for virtual surgical planning by identifying the position and angulation of the dental implant that is possible within a fibula.

According to first aspect, there is provided a computer-implemented method for automatic identification of a dental implant position in a bone, comprising the steps of:
receiving a dental implant parameter,
generating a digital bone model of the bone, wherein the bone is a fibula,
identifying an anterior aspect of the fibula,
determining an implant position in the fibula.

The computer implemented method provides an automated method to identify an ideal or optimal position for a dental implant in a fibula in fibula free flap (i.e. fibula free flap procedure). The computer implemented method is advantageous because it automatically determines an optimal position for a dental implant. The computer implemented method is advantageous because it automates analysis of fibula morphology and reduces the dependency on complex engineering and computer aided design (CAD) skills.

In one example, the method further comprising the step of presenting the implant position in the fibula on a user interface.

In one example the method comprising the step of orienting the bone model along the anterior aspect of the fibula and in a vertical orientation.

In one example the method comprising the step of determining the direction of the implant based on the anterior aspect of the fibula.

In one example the method comprising the additional steps of:
segmenting digital bone model into multiple segments along its length,
determining a cross section of the fibula at each segment,
calculating a maximum length of implant possible at each segment based on the cross section and length of each segment.

In one example, the method comprising the step of segmenting the fibula into at least six segments, calculating a cross-sectional area or a largest cross-sectional dimension for each segment, and determining the maximum implant length or implant size possible in each segment. In one example, the fibula is segmented into six segments only. Alternatively, the fibula may be segmented into more than six segments e.g., eight segments.

In one example, the method may comprise the step of identifying the segment of the fibula that can be used to position the implant based on the implant parameter and at least one of a cross-sectional area or largest cross-sectional dimension of each segment.

In one example the dental implant parameter may be implant diameter, or implant cross-sectional area, or longest implant dimension or implant angle. Alternatively, or additionally, the implant parameter may be an implant length.

In one example, the method identifies regions of the fibula unsuitable for a dental implant. For example, the method comprises the step of identifying an apex of the fibula head and a lateral malleolus in the bone model, calculating 8 cm from the apex of the fibula head and the lateral malleolus, identifying this length as unsuitable for a dental implant and presenting this length on the bone model and/or on a user interface.

In one example the unsuitable fibula region may correspond to at least 20% of the fibula. 60% of the fibula may be identified as suitable for a dental implant.

In one example the method comprising the step of automatically identifying the one or more bone segments that can receive the dental implant and the angulation of the dental implant within the bone segment.

In one example the digital bone model is a stereolithography model of the fibula.

According to a further aspect there is provided a data processing apparatus for automatic identification of a dental implant position in a bone comprising means for carrying out the method as describe above.

According to a further aspect there, is provided a computer program comprising instructions which, when the program is executed by a computing apparatus, cause the computing apparatus to carry out the method of any one of method statements above.

According to a further aspect, there is provided a computer-readable medium comprising instructions which, when executed by a computing apparatus, cause the computing apparatus to carry out the method as described above.

According to a further aspect, there is provided a system for automatically identifying a dental implant position in a bone comprising:
a computing apparatus comprising a processor and a memory unit, the processor and memory unit being operatively coupled to each other,
the memory unit adapted to store instructions which, when executed by the processor cause the computing apparatus to carry out the method of any one of the method statements above.

According to a further aspect, there is provided a system for automatic identification a dental implant position in a bone comprising:
a computing apparatus comprising a processor and a memory unit, the processor and memory unit being operatively coupled to each other,
the memory unit adapted to store instructions which, when executed by the processor the computing apparatus is configured to:
receive a dental implant parameter,
generate a digital bone model of the bone, wherein the bone is a fibula,
identify an anterior aspect of the fibula,
determining an implant position in the fibula.

The system provides an automated method to identify an optimal position for a dental implant in a fibula, which can be used in a fibula free flap procedure. The system is advantageous because it provides an automated tool that is accessible for surgeons to use without relying on complex engineering analysis and CAD skills. The system allows a surgeon to get an indication of an optimal position of a dental implant within the fibula in a cost and time effective manner.

In one example, the computing apparatus is configured to orient the bone model along the anterior aspect of the fibula and in a vertical orientation.

In one example the computing apparatus is configured to determine the direction of the implant based on the anterior aspect of the fibula. The computing apparatus may further be configured to calculate a cross-sectional area of the fibula in the bone model and determine the appropriate angulation of the implant based on the anterior aspect and the cross-sectional area.

In one example, the computing apparatus is configured to:
segment digital bone model into multiple segments along its length,
determine a cross section of the fibula at each segment,
calculate a maximum length of implant possible at each segment based on the cross section and length of each segment.

In one example, the computing apparatus is configured to segment the fibula into at least six segments, calculate a cross-sectional area or a largest cross-sectional dimension for each segment, and determine the maximum implant length or implant size possible in each segment.

In one example, the computing apparatus is configured to identify the segment of the fibula that can be used to position the implant based on the implant parameter and the largest cross-sectional dimension of each segment. Optionally, the implant parameter may be a cross-sectional area.

In one example the dental implant parameter may be one of implant diameter, or implant cross-sectional area, or implant length, or implant angle. In one example, an implant width may be used as the dental implant parameter.

In one example, the computing apparatus is configured to identify regions of the fibula unsuitable for a dental implant. For example, the computing apparatus may be configured to identify an apex of the fibula head and a lateral malleolus in the bone model, calculating 8 cm from the apex of the fibula head and the lateral malleolus, identifying this length as unsuitable for a dental implant and presenting this length on the bone model and/or on a user interface.

According to a further aspect, there is provided a machine-learning model for automatic identification of a dental implant position in a bone e.g., a fibula, in particular for use in the method of any one of the earlier method statements. In one example, the model may be a deep neural network or graph neural network or another suitable neural network.

According to a further aspect, there is provided a system for automatically identifying a dental implant position in a bone comprising:
a computing apparatus comprising a processor and a memory unit, the processor and memory unit being operatively coupled to each other,
the memory unit adapted to store instructions which, when executed by the processor cause the computing apparatus to:
   receive a dental implant parameter,
   generate a digital bone model of the bone, wherein the bone is a fibula,
   identify an anterior aspect of the fibula,
   determine an implant position in the fibula.

In one example, the computing apparatus is configured to orient the bone model along the anterior aspect of the fibula and in a vertical orientation.

In one example, the computing apparatus is configured to:
orient the bone model along the anterior aspect of the fibula and in a vertical orientation, and;
determine the direction of the implant based on the anterior aspect of the fibula.

In one example, the computing apparatus is configured to:
segment digital bone model into multiple segments along its length,
determine a cross section of the fibula at each segment, and;
calculate a maximum length of implant possible at each segment based on the cross section and length of each segment; and
identify the one or more bone segments that can receive the dental implant and the angulation of the dental implant within the bone segment.

In one example, the computing apparatus is configured to:
segment the fibula into at least six segments,
calculate a cross-sectional area or a largest cross-sectional dimension for each segment, and
determine the maximum implant length or implant size possible in each segment.

The system of claim 15, wherein the computing apparatus is configured to:
identify the segment of the fibula that can be used to position the implant based on the implant parameter and at least one of a cross-sectional area or largest cross-sectional dimension of each segment, and;
wherein the dental implant parameter may be one or more of: implant diameter, or implant cross-sectional area, or longest implant dimension or implant angle.

In one example, the computing apparatus is configured to:
identify an apex of the fibula head and a lateral malleolus in the bone model,
calculate at least 8 cm from the apex of the fibula head and the lateral malleolus, identify this length as unsuitable for a dental implant and;
present this length on the bone model and/or on a user interface, and;
wherein the unsuitable fibula region is at least 20% of the fibula and at least 60% of the fibula may be identified as suitable for a dental implant.

According to a further aspect, there is provided a non-transitory computer readable medium comprising instructions that, when executed by a processor cause the processor to perform the steps of a method for automatic identification of a dental implant position in a bone, wherein the comprising the steps of:
receiving a dental implant parameter,
generating a digital bone model of the bone, wherein the bone is a fibula,
identifying an anterior aspect of the fibula, and;
orienting the bone model along the anterior aspect of the fibula and in a vertical orientation,
determining the direction of the implant based on the anterior aspect of the fibula,
determining an implant position in the fibula and; wherein the digital bone model is a stereolithography model of the fibula, and;
presenting the implant position in the fibula on a user interface.

In one example, the non-transitory computer readable comprising instructions that, when executed by the processor cause the processor to perform the additional steps of:
segmenting digital bone model into multiple segments along its length,
determining a cross section of the fibula at each segment,
calculating a maximum length of implant possible at each segment based on the cross section and length of each segment,
identifying the segment of the fibula that can be used to position the implant based on the implant parameter and at least one of a cross-sectional area or largest cross-sectional dimension of each segment, and;
wherein the dental implant parameter may be one or more of: implant diameter, or implant cross-sectional area, or longest implant dimension or implant angle.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art.

### BRIEF DESCRIPTION OF THE DRAWINGS

Illustrative example embodiments will now be described, by way of example, with reference to the accompanying drawings in which:

FIG. 1 illustrates one example for of a system for automatic identification of a dental implant position in a bone, in particular for dental implant position in a fibula.

FIG. 2 illustrates a schematic diagram of a computing apparatus that forms the system for automatic identification of a dental implant of FIG. 1.

FIG. 3 illustrates a flow chart of one example of a method for automatic identification of a dental implant position in a bone, in particular for dental implant position in a fibula.

FIG. 4 illustrates a 3D fibula model with an anterior aspect presented on the model.

FIG. 5 illustrates an example of the fibula model with the fibula head and lateral malleolus being identified and various segments of the bone being identified on the model.

FIG. 6 illustrates one of four different methods to calculate the largest cross-sectional dimension of a fibula.

FIG. 7 illustrates one of four different methods to calculate the largest cross-sectional dimension of a fibula.

FIG. 8 illustrates one of four different methods to calculate the largest cross-sectional dimension of a fibula.

FIG. 9 illustrates one of four different methods to calculate the largest cross-sectional dimension of a fibula.

FIG. 10 illustrates the largest cross-sectional dimension in each segment of the fibula.

FIG. 11 illustrates a calculated rectangle which represents the dimension of the implant.

FIG. 12 illustrates the maximum possible implant at each cross section B-H.

FIG. 13 illustrates an example of the different implant angulations and the maximum implant size for the different angulations.

FIG. 14 illustrates various rectangles that fit into the bone segment.

### DETAILED DESCRIPTION OF THE EXAMPLE EMBODIMENTS

Fibula free flap procedure is a commonly used procedure in reconstructive surgery to replace a missing bone and/or soft tissue, often in mandibular or maxillofacial reconstruction following trauma, cancer resection, or congenital deformities, allowing the rehabilitation of occlusion, chewing, swallowing, speech and aesthetics. Apart from explicit surgical planning and execution, successful functional reconstruction of jaw defects requires a thorough understanding of fibula morphology. The size of the selected implant depends on the height and width of available bone, however, determining the ideal implant position at fibula segments could be difficult as its cross-sectional shape and dimension varies along its length. Therefore, precise evaluation of bone dimensions and morphology are important for the precise pre-operative planning of simultaneous dental implant placement.

The present disclosure relates to a method and system for automatic identification of a dental implant position on a bone. In particular, the present disclosure relates to a method and system for automatic identification of a dental implant position in a fibula of a patient. The present disclosure relates to a system that analyses fibula cross section using a computer software to facilitate implant placement in a fibula bone. The method and system can also be used for identification of a dental implant position in another long bone such as a ulna or tibia.

The present disclosure also relates to a non transitory computer readable medium comprising instructions that, when executed by a processor cause the processor to perform the steps of a method for automatic identification of a dental implant position in a bone.

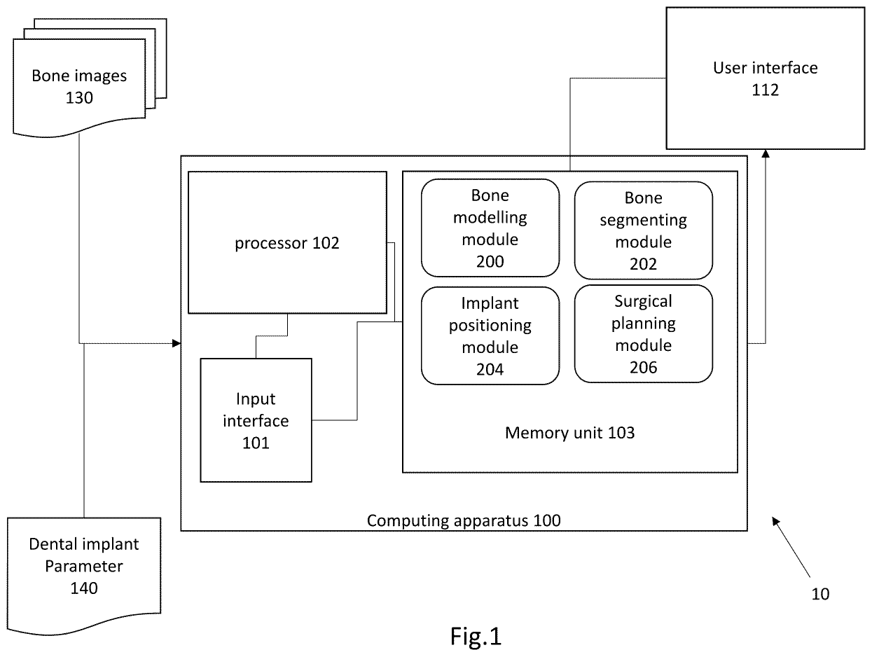

Referring to FIG. 1, an example embodiment of a system 10 for automatic identification a dental implant position in a bone is illustrates. The system 10 comprising: a computing apparatus 100 comprising a processor 102 and a memory unit 103, the processor 102 and memory unit 103 being operatively coupled to each other, the memory unit 103 adapted to store instructions which, when executed by the processor the computing apparatus is configured to: receive a dental implant parameter 140, generate a digital bone model of the bone from one or more received bone images 130, wherein the bone is a fibula, identify an anterior aspect of the fibula, determining an implant position in the fibula. In one example, the implant position may be the optimal position for an implant in the fibula.

In one example, the computing apparatus 100 may receive an implant parameter 140 e.g., a diameter of the implant or length of the implant. Optionally, the implant parameter may also be an implant width. Optionally, the implant parameter or parameters may be input by a clinician e.g., via the user interface 112. The apparatus 100 may further receive one or more bone images e.g., CT scans of a fibula or stereolithographic models of a fibula. The apparatus may be configured to process the one or more bone images and determine a 3D digital bone model e.g., a 3D digital fibula model. In one example the digital bone model is a stereolithography model of the fibula.

In one example, the computing apparatus is configured to orient the bone model along the anterior aspect of the fibula and in a vertical orientation. The computing apparatus 100 is configured to: segment digital bone model into multiple segments along its length, determine a cross section of the fibula at each segment, calculate a maximum length of implant possible at each segment based on the cross section and length of each segment. The computing apparatus is further configured to identify the bone segment where an implant can be placed i.e., a position of the bone for an implant and present this on a user interface.

The memory unit 103 may be a non-transitory computer readable medium comprising readable and executable instructions that, when executed by the processor 102, cause the processor 102 to perform one or more steps of a method 300 for automatic identification of dental implant position in a bone e.g., a fibula. In one example, the processor may perform the steps of method 300.

The system 10 may comprise a user interface 112 e.g., a display or a screen that is operatively coupled to the computing apparatus 100. In the illustrated example, the user interface 112 may be a separate component. Alternatively, the user interface 112 may be integrated into the computing apparatus 100. The user interface 112 may be configured to display the fibula model (i.e., bone model) and present the implant position in the fibula on the bone model. The bone model and the position for an implant being presented on the user interface allows a clinician to make a clinical assessment regarding the suitability of the fibula for the implant and allow a clinician to make other assessments. The user interface 112 may display the identified segment that is most appropriate for the selected implant.

The determination of the optimal position for an implant and presenting this data on the user interface 112 also allows a clinician to virtually plan a surgery e.g., virtually plan a fibula free flap procedure. The system allows a clinician to change implant parameters e.g. implant length or diameter and the system is configured to calculate and identify an optimal position for the updated implant in the fibula. This is advantageous because the system allows a user e.g., a clinician to quickly, cost effectively identify the optimal position for an implant and allow for virtual surgery planning.

In this example embodiment, the system for automatic identification a dental implant position in a bone may be implemented by a computing apparatus 100 (i.e., computer) having an appropriate user interface. The computing apparatus 100 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing apparatus 100 may be appropriately programmed to implement the a computer-implemented method for automatic identification of a dental implant position in a bone such as for example a fibula.

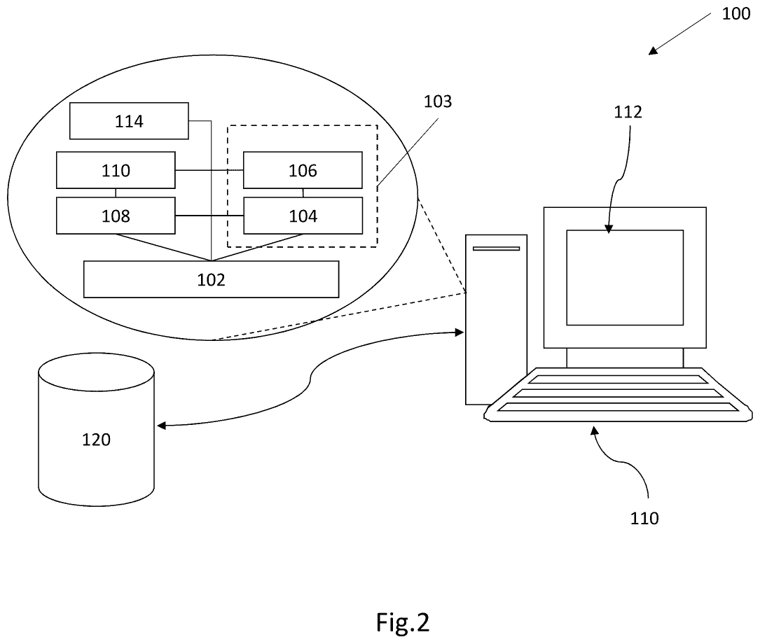

As shown in FIG. 2 there is a shown a schematic diagram of a computing apparatus 100 which is arranged to be implemented as an example embodiment of a system 10 for automatic identification a dental implant position in a bone. In this embodiment comprises a computing apparatus 100 which includes suitable components necessary to receive, store and execute appropriate computer instructions. The components may include a processor 102 (i.e., a processing unit), including Central Processing Unit (CPU), Math Co-Processing Unit (Math Processor), Graphic Processing Unit (GPUs) or Tensor processing unit (TPUs) for tensor or multi-dimensional array calculations or manipulation operations, and a memory unit 103.

The memory unit 103 may comprise one or more of read-only memory (ROM) 104, random access memory (RAM) 106. The computing apparatus 100 may further comprise input/output devices such as disk drives 108, input devices 110 such as an Ethernet port, a USB port, or a keyboard etc. In one example the ROM or RAM or disk drives may each be non-transitory computer readable mediums.

The system 10 may comprise a user interface i.e., display 112 such as a liquid crystal display, a light emitting display or any other suitable display and communications links 114. The computing apparatus 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The computing apparatus 100 may include storage devices such as a disk drive 108 which may encompass solid state drives, hard disk drives, optical drives, magnetic tape drives or remote or cloud-based storage devices. The computing apparatus 100 may use a single disk drive or multiple disk drives, or a remote storage service. The server 100 may also have a suitable operating system which resides on the disk drive or in the ROM of the computing apparatus 100.

The computing apparatus may further comprise one or more databases 120 adapted to store one or more pieces of data. For example, the apparatus 100 may include a database of fibula models that include one or more 3D bone models or virtual stereolithographic models of a fibula. The computing apparatus 100 may include a database of dental implant models, e.g., predefined 3D dental implant models.

Optionally, the computing apparatus 100 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus 100 may comprise one or more GPUs being operatively coupled to the CPU (i.e., processor). The computing apparatus may comprise additional hardware elements operatively coupled to the CPU and/or the GPU to provide the computing apparatus components needed to implement a machine learning network or machine learning model. The learning network or model may be stored in a memory unit e.g., ROM.

Optionally, the machine learning network e.g., a deep neural network may be trained to process a fibula bone model and identify an optimal position for a dental implant based on identifying dimensions of the fibula at different points of the fibula. The machine learning network may be trained on several data points of various patients'fibula data. The machine learning network may be trained to receive an input of a dental implant parameter or parameters, and a patient's fibula image or fibula model. The machine learning network may be configured to automatically identify an optimal position for the dental implant in the patient's fibula. The optimal location may be presented on the user interface 112 e.g., on the display.

Referring to FIG. 1, the system 10 may include one or more modules that are configured or programmed to perform one or more functions. As shown in FIG. 1, the computing apparatus may optionally comprise a bone modelling module 200, a bone segmenting module 202, an implant positioning module 204 and a surgical planning module 206. The modules 200-206 may be software modules that may be stored in a memory unit 103 and executed by the processor 102. The modules 200-206 may include computer readable and executable instructions that may be executable by the processor 102. Functions of each optional module will be described.

The bone modelling module 200 may be configured to receive one or more bone images e.g., CT scans of a fibula. The bone modelling module 200 may be configured to generate a 3D bone model, i.e., a 3D model of the fibula by processing the CT scans. The bone modelling module 200 may further be configured to calculate a central axis of the fibula and fitting a line to represent the axis. The bone modelling module 200 may be further configured to calculate an anterior aspect of the fibula and orient the fibula vertically along a z axis of the bone.

The optional bone segmenting module 202 may be configured to segment the fibula into multiple segments. For example, the module 202 may be configured to segment the fibula into at least six segments. The distance between each segment may be user defined. The segments may be displayed on the 3D fibula model and presented on the user interface 112.

The optional implant positioning module 204 may be configured to determine a cross-sectional area or the largest cross-sectional dimension. For example, the cross-sectional dimension may be distance (or width) that is parallel to a y axis of the bone model. The y axis may be along a horizontal plane. The implant positioning module 204 may be configured to calculate the longest (i.e., largest) cross-sectional dimension using one of four methods (described later). The implant positioning module 204 may be configured to identify the segment where the implant can fit based on the implant parameters. The module 204 may be configured to represent the implant as a rectangle. The rectangle may be compared with the cross sections or cross-sectional dimension to determine the ideal angulation and length of the dental implant in the fibula section. The module 204 may be configured to identify the appropriate segment that fits the implant. The segment may be displayed on the user interface 112.

The optional surgical planning module 206 may be configured to determine an optimal surgical process to create the implant from the fibula. The surgical planning module 206 may be further configured to determine cutting locations and shape of cuts to form an implant in the fibula.

In one example, the modules 200-206 may be stored as software modules that may be executed by the processor 102. The processor 102 executing the software modules 200-206 may cause the computing apparatus 100 to perform a method for automatic identification a dental implant position in a bone. Additionally, the computing apparatus 100 may also be configured to allow a clinician to virtually plan a surgery to create the implant. In an alternative form each of the modules 200-206 may be hardware modules that may be operatively coupled to each other. In this alternative form, each of the modules 200-206 may be microprocessors that may execute the functions described herein. The hardware modules 200-206 may be executed in use and cause the computing apparatus 100 to automatically identify a dental implant position in a bone.

In one example, there is provided a method for automatic identification of a dental implant position in a bone. The method comprises the steps of receiving a dental implant parameter, generating a digital bone model of the bone, wherein the bone is a fibula, identifying an anterior aspect of the fibula, and determining an implant position in the fibula. The method may comprise the additional steps of the additional steps of segmenting digital bone model into multiple segments along its length, determining a cross section of the fibula at each segment, calculating a maximum length of implant possible at each segment based on the cross section and length of each segment.

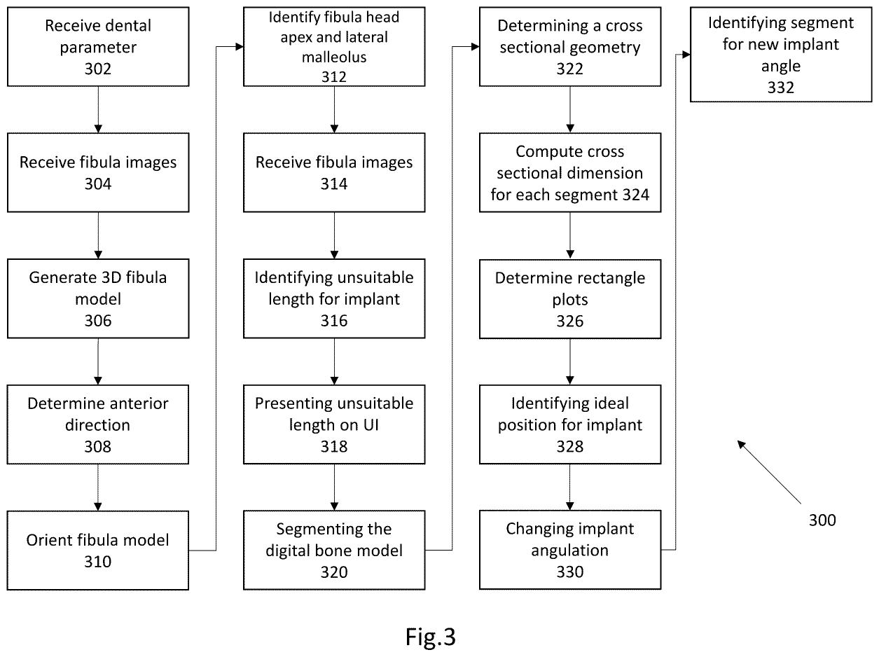

FIG. 3 illustrates an example embodiment of a method 300 for automatic identification of a dental implant position in a bone. The method 300 commences at step 302. Step 302 comprises receiving a dental implant parameter. The dental implant parameter may be entered by the clinician via the user interface 112 for example. The dental implant parameter may be related or customized to a patient. The dental implant parameter may include one or more of implant diameter, implant length, implant angle etc.

Step 304 comprises receiving images of a bone, wherein the bone is a fibula. The images of the fibula may be digital image such as for example CT scans or X ray images. Step 306 comprises generating a digital bone model of the bone from the one or more images. The bone is a fibula. Optionally, the method 300 may comprise receiving a 3D bone model.

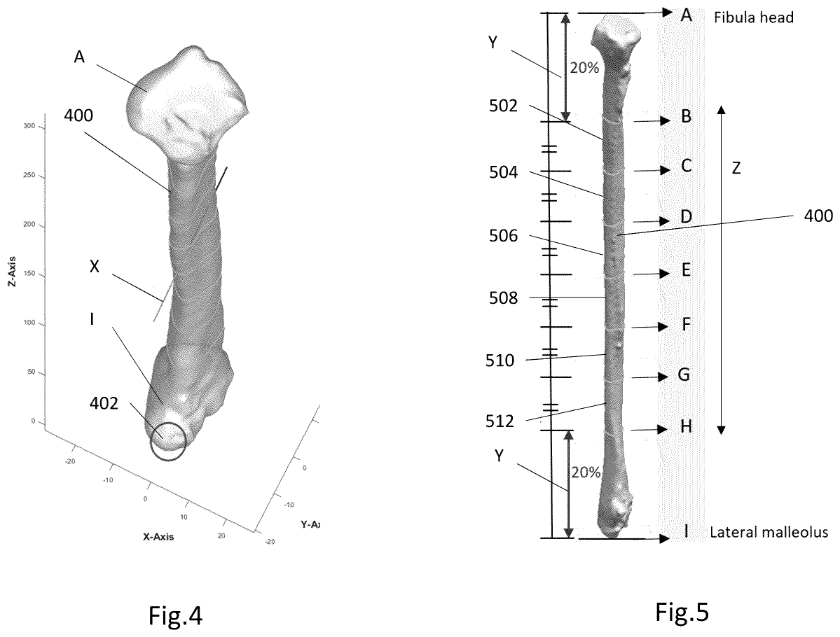

FIGS. 4 and 5 illustrate a 3D bone model 400 of the fibula. Referring to FIG. 4 a 3D bone model i.e., a 3D model or a 3D representation of the fibula is generated by processing the received bone images 130. The images may be images of the fibula. The bone model may be generated by a suitable algorithm or computer program or suitable image processing method.

Step 308 comprises identifying an anterior aspect of the fibula in the 3D model. FIG. 4 illustrates a line X that indicates an anterior aspect of the fibula model 400. The algorithm (i.e., method 300) identified the anterior direction of fibula using the most protruded part, which involved calculating the distance of each point from the central axis, identifying the furthest group of points, and computing their average vector to represent the anterior direction of the bone. The function was employed to calculate the anterior and posterior directions of the object represented by the point cloud. The most protruded part 402 is illustrated by the circle.

Step 310 comprises orienting the fibula model in a vertical orientation. Once the anterior vector was calculated, the bone point cloud was rotated to align the anterior vector along the y-axis [0, 1, 0], ensuring consistent orientation of the anterior direction relative to the coordinate system. As shown in FIG. 4, the fibula model 400 is oriented in a vertical orientation and in an anterior direction.

Step 312 comprises identifying an apex of the fibula head and a lateral malleolus in the bone model. The apex of the fibula head and the lateral malleolus are identified in the fibula model 400 and presented on the user interface 112. FIG. 5 illustrates an example of the fibula model 400 with the fibula head being identified as feature A and the lateral malleolus is identified as feature I.

Step 314 comprises segmenting the digital bone model 400 into multiple segments along its length. The bone model 400 may be segmented into at least six segments. As shown in FIG. 5 the fibula model 400 is segmented (i.e., sliced) at seven different heights, determined by a specific mathematical function considering the length of the bone and other factors.

Step 316 identifying this length as unsuitable for a dental implant. Step 316 comprises calculating 20% of the length of the fibula from the apex of the fibula head A and calculating 20% of the length of the fibula from the lateral malleolus. In one example the step 316 may comprise calculating 8 cm from the apex of the fibula head A and 8 cm from the lateral malleolus I. The 8 cm length may be indicative of an unsuitable length of the fibula. The 8 cm length is not used for bone harvesting in order to maintain the integrity of the knee and ankle of the patient (wherein patient is the person who is receiving the implant). Length Z may be marked on the model and indicative of the available length for an implant. This may be approximately 60% of the fibula in one example.

Step 318 comprises presenting this length on the bone model as feature Y. The model 400 with the marked fibula head, lateral malleolus and the unsuitable length indicated as a user interface 112. Step 320 comprises segmenting the digital bone model 400 into multiple segments along its length. In the illustrated example of FIG. 5, the model 400 may be segmented into six segments along seven segment lines (i.e., cut lines) B, C, D, E, F, G, H as shown in FIG. 5. The six segments 502, 504, 506, 508, 510, 512 may be of equal dimension.

Step 322 comprises calculating a cross-sectional geometry of each segment. In one example the cross-sectional geometry may be a cross-sectional dimension. In another example the cross-sectional geometry may be a maximum cross-sectional dimension e.g., maximum cross-sectional width. In width may be dimension along the y axis of the fibula model 400. The cross-sectional geometry provides a detailed representation of the bone's structure at various heights, enabling a comprehensive understanding of its geometry and features. The distance between each segment 502-512 may be a user-defined parameter. The cutting plane for each segment intersects the facets of the fibula model, generating intersection points e.g., points labelled B to H in FIG. 5. Line segments m using two intersection points from the same facets to segment the available area for an implant Z, as shown in FIG. 5.

In one example the segments 502-512 may be connected together and arranged to form a closed contour, each representing a cross-section geometry e.g., cross section of the fibula model at each different slice height indicated by lines B to H in FIG. 5, and the lines indicated on FIG. 4.

The cross-sectional dimension for each segment may be calculated using one of four methods (i.e., algorithms). Four methods of cross-sectional geometry will now be described.

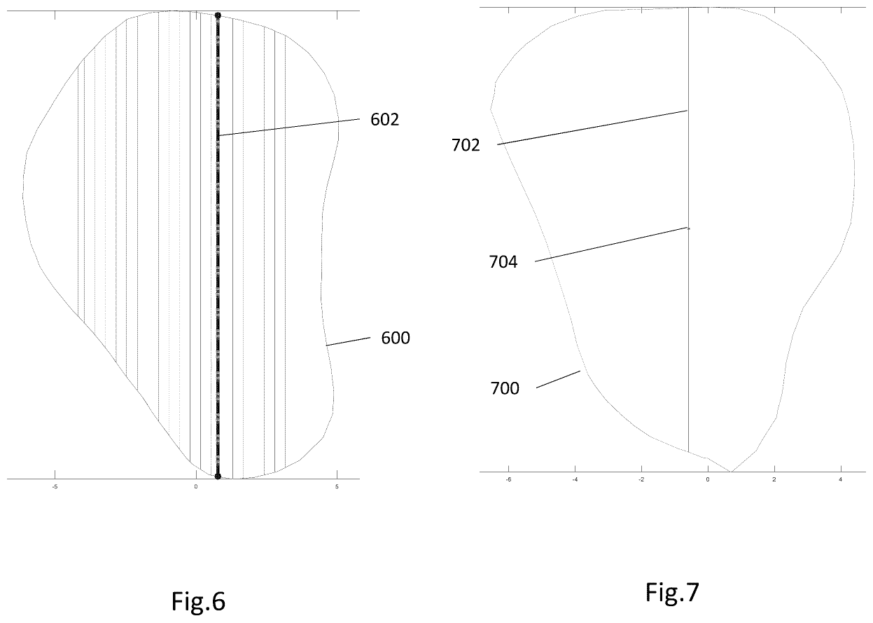

FIGS. 6 to 9 illustrate the four methods of determining a cross-sectional geometry i.e. a cross-sectional dimension. FIG. 6 illustrates a first method. Referring to FIGS. 6, 100 equidistant gridlines are drawn parallel to the y axis i.e., along an anterior direction on the cross section 600 of a segment as shown in FIG. 6. The line with the maximum length is identified as the central line 602. This line 602 is parallel to the y axis i.e., extends along the anterior aspect. The line 602 and its length represents the longest cross-sectional dimension.

FIG. 7 illustrates a second method. Referring to FIG. 7, a geometric centre point 704 for a cross-sectional shape 700 is calculated. A vertical line 702 is drawn through the geometric centre point e.g., along the y axis. This approach assumes the anterior direction is aligned with the y axis. The line 702 represents the longest cross-sectional dimension and represents the thickness of the bone in the anterior direction.

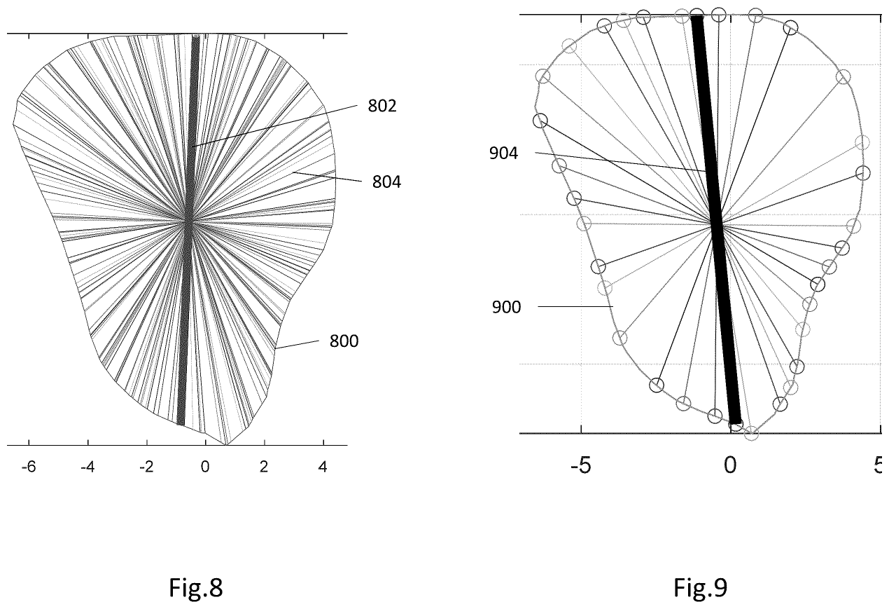

FIG. 8 illustrates a third method. Referring to FIG. 8, the third method to determine the cross-sectional dimension comprises computing the average position of all vertices in the contour and lines from each vertex of the contour are drawn. The lines all pass through the geometric centre and end on the opposite side. The lines are shown as 804 on the cross-sectional shape 800. The longest line 802 is identified.

FIG. 9 illustrates a fourth method. Referring to FIG. 9, the fourth method comprises starting with a reference line 904 which is continuously rotated around the midpoint of the cross-sectional shape 900. The midpoint 906 refers to the middle of the line itself. The reference line 904 is rotated at 1° increments. The method comprises analysing each orientation to find the one that allows the creation of the largest possible rectangle with a predetermined fixed width inside the polygon. The line 902 with the optimal orientation is then identified and utilised to identify the largest cross-sectional dimension.

The outputs of all the four methods identify the largest cross section dimension e.g., largest cross-sectional width of the fibula at the specific segment. The step 322 may comprise applying any one or more of the four methods to determine the largest cross-sectional dimension. The largest cross-sectional dimension indicates the widest i.e., thickest part of the fibula at a segment B-H.

Step 324 comprises computing the cross section geometry at each segment i.e., at each potential harvesting site. At the segment lines B-H, the cross section geometry (i.e., the largest cross-sectional dimension) may be calculated by applying each of the four methods described in reference to FIG. 6 to 9.

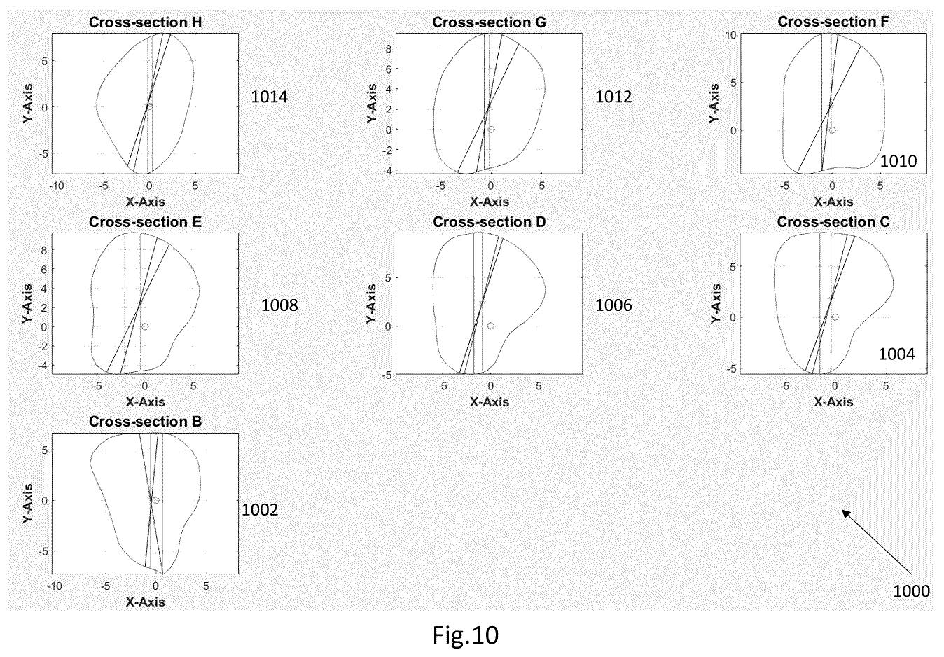

FIG. 10 1000 illustrates the largest cross-sectional dimension in each segment B-H according to each of the four methods described above in relation to FIGS. 6 to 9. A cross section at each segment B-H from FIG. 5, is illustrated. The segments are labelled 1002 to 1014. The largest cross-sectional dimension according to each method is calculated at each cross section 1002-1014.

Step 326 comprises determining a rectangle plot to represent the dimension of dental implants. The rectangle plot is generated based on the implant parameter e.g., the dimension and/or angulation of the implant. The rectangle may be calculated by a mathematical function. The function found the intersection points between the rectangle's lines and the polygon. Once the rectangle points of the rectangle plot were determined, the height of the rectangle is calculated by determining the maximum distance between the points in the diagonal of the distance matrix of the rectangle points.

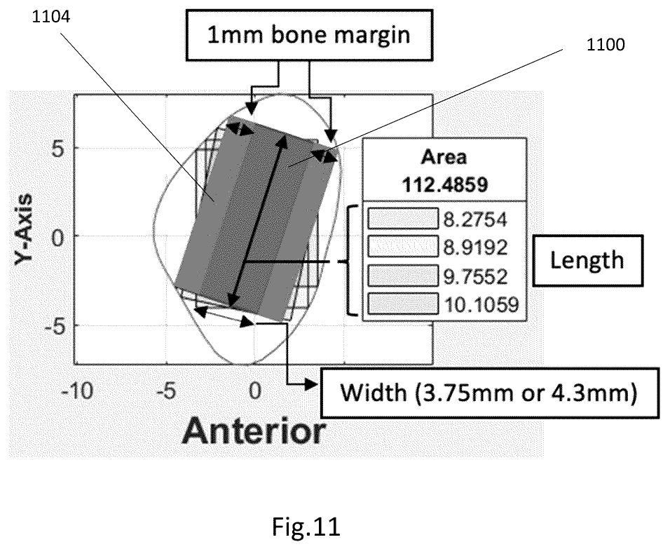

FIG. 11 illustrates a calculated rectangle 1100 which represents the dimension of the implant. The length of the rectangle corresponds to the maximal length of the implant that could be placed in the cross section of the fibula. The width of the rectangle represents implant diameter and an additional 1 mm bony collar on both sides. The wider rectangle 1102 represents the bony collar i.e., bone margin on lateral and medial aspects. The 1 mm collars ensure no implant thread exposure through the bone. Four rectangles, generated by the four corresponding algorithms as mentioned above, may be displayed corresponding to different implant length and angulation.

In one example, only one cross-sectional dimension may be calculated using a single method (i.e., algorithm). In this example, a cross-sectional length may be calculated using only the method shown in FIG. 9. In this method, only a single algorithm (or method) may be used to calculate the cross-sectional dimension, as it provides the most accurate estimate.

Alternatively, in one example multiple algorithms or methods described may be used to calculate each rectangle. In this alternative example, all four algorithms may be used to calculate each rectangle. Each rectangle may be determined as an averaged output from all four algorithms.

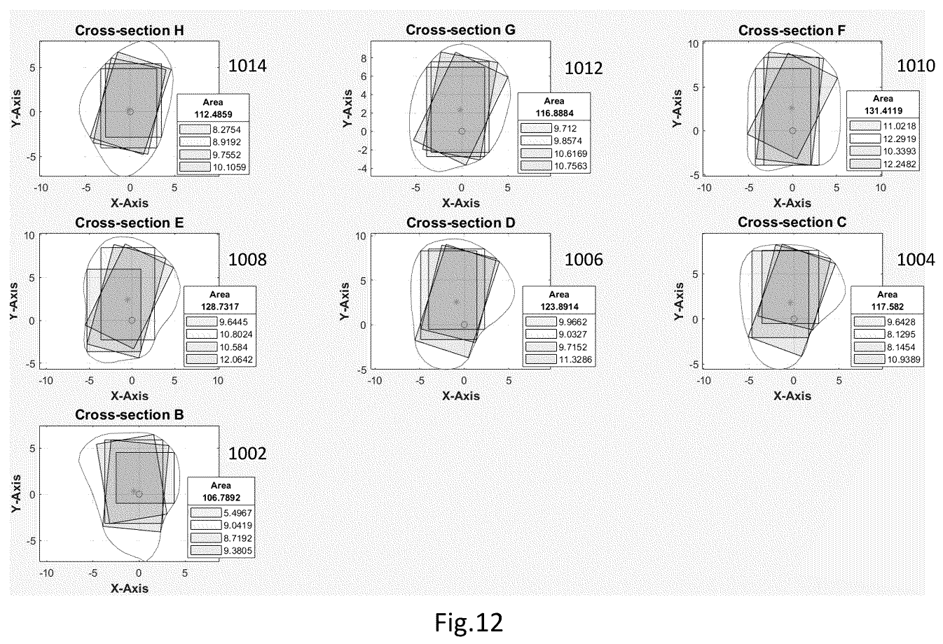

Considering the surgical feasibility (i.e. from the anterior or lateral aspect of fibula to the posterior border) and avoidance of the postero-medial portion to prevent interruption to the blood supply from pedicle, the maximum possible length of the implant was recorded at each segment i.e., at each cross-section B-H. This is represented in FIG. 12. FIG. 12 illustrates the maximum possible implant at each cross section B-H, as per FIG. 5. A maximum possible implant at each section 1002-1014 (sections B-H) is illustrated in FIG. 12 by the rectangles. The rectangles may correspond to a maximum possible implant.

In one example each rectangle may correspond to or may be calcuated based on a cross-sectional dimension calculated based on each of the methods shown in FIGS. 6 to 9.

Step 328 comprises identifying the ideal segments (i.e., ideal locations) of the fibula that can fit the implant based on the dimensions of the segment and the implant parameters. The identified segments may be displayed on a user interface to allow a clinician to make a decision on the ideal position in the fibula for the implant. The ideal location may correspond to the segment or the section line B-H for the implant to be inserted or attached to the fibula. The ideal location indicates the best position of the fibula for implant placement.

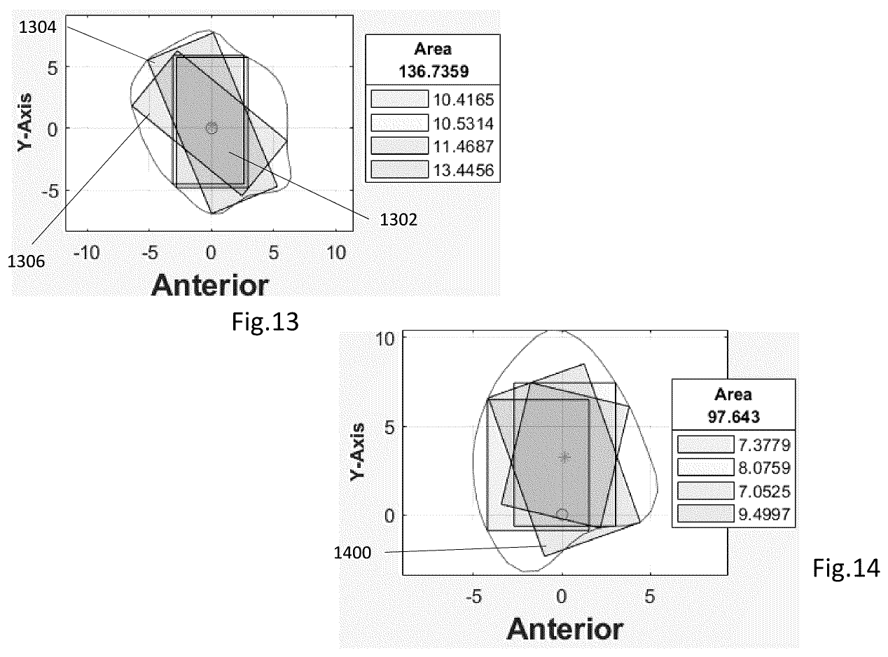

The system provides a virtual surgical planning system that allows a clinician to change implant parameters or the aspect of the implant. Step 330 comprises changing implant angulation. The angulation may be changed by changing the aspect i.e., inserting the implant from anterior aspect or a lateral aspect or medial aspect or other aspect. Step 332 comprises identifying the segments where the implant with a changed aspect can be inserted. A clinician may be able to change the aspect for the implants via the user interface. FIG. 13 illustrates an example of the different implant angulations and the maximum implant size for the different angulations. The rectangle 1300 is indicative of the maximum implant size that can fit into the fibula when the implant is inserted in an anterior aspect. The rectangles 1302, 1304 and 1306 indicate implant sizes when inserted at different aspects.

The method 300 may identify an implant that would not fit into the bone. FIG. 14 illustrates various rectangles that fit into the bone segment. The rectangle 1400 extends beyond the fibula contour. This may be presented on a user interface 112. If the implant is calculated to not fit in the fibula, an alarm may be raised. The system 10 allows a user, e.g., clinician to change implant parameters and then repeat the method 300 to automatically identify an implant position in the fibula.

The method 300 may be a defined as computer readable and executable instructions. The instructions may be embodied as a computer program. The computer program may comprise instructions, which when the program is executed by the computing apparatus 100 cause the computing apparatus to carry out the method 300. The computer program may be stored on a non-transitory computer readable medium e.g., memory 103.

The system may comprise a non-transitory computer-readable medium e.g., a memory unit 103 comprising instructions which, when executed by the computing apparatus, cause the computing apparatus to carry out the method 300 to identify the ideal position in a fibula for an implant. The method 300 may be executed by the processor 102. In one example various parts of the method 300 may be executed by the various modules 200 to 206.

The disclosure provides a system that focusses on the analysis of fibula cross-section using computer software to facilitate dental implant placement in fibula bone or in another suitable bone. The system is advantageous as it provides an easy to use and automated system that facilitates dental implant placement in a fibula bone. The computer program may be stored in a memory e.g., a non transitory computer readable medium and may be executed by a processor. The system and method are advantageous as they facilitate identifying an optimal placement of a dental implant in a bone e.g., a fibula bone. The system and method are advantageous as it fibula bone area e.g., sectional area is maximised for dental implant placement.

The described system and method for automatic identification of a dental implant position in a fibula provide an improvement in the existing process of fibula implant planning for jaw reconstruction using computer-assisted surgery. The method provides a more efficient and user-friendly process to identify a location in a bone that is ideal for a selected implant. The system and method for automatic identification of dental implant position in a fibula automates the analyses of fibula morphology and several design steps, reducing the dependency on advanced engineering skills and making the process more accessible to surgeons. The method and system significantly reduce the time spent on implant planning in fibula free flaps, allowing for rapid alterations to the design in a matter of minutes.

The system and method provide for better dental rehabilitation and orientation of fibula segments. The algorithm i.e., method adjusts the angulation of the implant based on the fibula morphology and bone available at cross-sections. Hence, allowing better utilization of fibula segments and maximising the longevity and stability of the implant. The system and method provide improved surgical planning and patient outcomes. Specifically, the system and method achieve the improved outcomes by simplifying the design process and making it more efficient. The system and method as described herein have the potential to improve surgical planning, leading to better patient outcomes.

Overall, the system and method as described herein offer a more efficient, accessible, and durable solution for the planning of simultaneous fibula implants compared to existing methods in the field of computer-assisted surgery for functional jaw reconstruction. The algorithm's (i.e., method 300) unique ability to adjust the size and position of the implant according to fibula morphology and bone available at different cross-sections, ensures the longevity and stability of the implant.

The conventional practice of virtual surgical planning involves manual analysis of fibula cross-section anatomy along its length and trial and error with different implant dimensions. The method and system as described herein will allow automation of the above time-consuming process and recognise the segments that are most suitable for dental implant placement. This in turn will determine the length and angulation of implants as well as the orientation of fibula segments in functional jaw reconstruction in a time-saving manner.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present disclosure are either wholly implemented by computing apparatus or computing system or partly implemented by computing systems then any appropriate computing system architecture may be utilised. This will include stand alone computers, network computers and dedicated hardware devices. Where the terms “computing system” or “computing apparatus” and “computing device” are used, these terms are intended to cover any appropriate arrangement of computer hardware capable of implementing the function described.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the disclosure. Additional elements or components may also be added without departing from the scope of the disclosure. Additionally, the features described herein may be implemented in software, hardware, as a business method, and/or combination thereof.

It will be appreciated by persons skilled in the art that numerous variations and/or modifications may be made to the disclosed embodiments without departing from the spirit or scope of the embodiments as broadly described. The present embodiments or arrangements are, therefore, to be considered in all respects as illustrative and not restrictive.

1. A computer-implemented method for automatic identification of a dental implant position in a bone, comprising the steps of:
receiving a dental implant parameter,
generating a digital bone model of the bone, wherein the bone is a fibula,
identifying an anterior aspect of the fibula,
determining an implant position in the fibula.

2. The method of claim 1, further comprising the step of presenting the implant position in the fibula on a user interface.

3. The method of claim 2, comprising the step of orienting the bone model along the anterior aspect of the fibula and in a vertical orientation.

4. The method of claim 3, comprising the step of determining the direction of the implant based on the anterior aspect of the fibula.

5. The method of claim 3, comprising the steps of:
segmenting digital bone model into multiple segments along its length,
determining a cross section of the fibula at each segment,
calculating a maximum length of implant possible at each segment based on the cross section and length of each segment.

6. The method of claim 5, comprising the step of identifying the one or more bone segments that can receive the dental implant and the angulation of the dental implant within the bone segment.

7. The method of claim 6, wherein the digital bone model is a stereolithography model of the fibula.

8. The method of claim 5 comprising the steps of:
segmenting the fibula into at least six segments,
calculating a cross-sectional area or a largest cross-sectional dimension for each segment, and
determining the maximum implant length or implant size possible in each segment.

9. The method of claim 8 comprising the step of:
identifying the segment of the fibula that can be used to position the implant based on the implant parameter and at least one of a cross-sectional area or largest cross-sectional dimension of each segment, and;
wherein the dental implant parameter may be one or more of: implant diameter, or implant cross-sectional area, or longest implant dimension or implant angle.

10. The method of claim 9 comprising the steps of:
identifying an apex of the fibula head and a lateral malleolus in the bone model,
calculating at least 8 cm from the apex of the fibula head and the lateral malleolus, identifying this length as unsuitable for a dental implant and;
presenting this length on the bone model and/or on a user interface.

11. The method of claim 10 wherein the unsuitable fibula region is at least 20% of the fibula and at least 60% of the fibula may be identified as suitable for a dental implant.

12. A system for automatically identifying a dental implant position in a bone comprising:
a computing apparatus comprising a processor and a memory unit, the processor and memory unit being operatively coupled to each other,
the memory unit adapted to store instructions which, when executed by the processor cause the computing apparatus to:
receive a dental implant parameter,
generate a digital bone model of the bone, wherein the bone is a fibula,
identify an anterior aspect of the fibula,
determine an implant position in the fibula.

13. The system of claim 12, wherein computing apparatus is configured to orient the bone model along the anterior aspect of the fibula and in a vertical orientation.

14. The system of claim 13, wherein the computing apparatus is configured to:
orient the bone model along the anterior aspect of the fibula and in a vertical orientation, and;
determine the direction of the implant based on the anterior aspect of the fibula.

15. The system of claim 14, wherein the computing apparatus is configured to:
segment digital bone model into multiple segments along its length,
determine a cross section of the fibula at each segment, and;
calculate a maximum length of implant possible at each segment based on the cross section and length of each segment; and
identify the one or more bone segments that can receive the dental implant and the angulation of the dental implant within the bone segment.

16. The system of claim 14, wherein the computing apparatus is configured to:
segment the fibula into at least six segments,
calculate a cross-sectional area or a largest cross-sectional dimension for each segment, and
determine the maximum implant length or implant size possible in each segment.

17. The system of claim 15, wherein the computing apparatus is configured to:
identify the segment of the fibula that can be used to position the implant based on the implant parameter and at least one of a cross-sectional area or largest cross-sectional dimension of each segment, and;
wherein the dental implant parameter may be one or more of: implant diameter, or implant cross-sectional area, or longest implant dimension or implant angle.

18. The system of claim 17, wherein the computing apparatus is configured to:
identify an apex of the fibula head and a lateral malleolus in the bone model,
calculate at least 8 cm from the apex of the fibula head and the lateral malleolus, identify this length as unsuitable for a dental implant and;
present this length on the bone model and/or on a user interface, and;
wherein the unsuitable fibula region is at least 20% of the fibula and at least 60% of the fibula may be identified as suitable for a dental implant.

19. A non-transitory computer readable medium comprising instructions that, when executed by a processor cause the processor to perform the steps of a method for automatic identification of a dental implant position in a bone, wherein the comprising the steps of:
receiving a dental implant parameter,
generating a digital bone model of the bone, wherein the bone is a fibula,
identifying an anterior aspect of the fibula, and;
orienting the bone model along the anterior aspect of the fibula and in a vertical orientation,
determining the direction of the implant based on the anterior aspect of the fibula,
determining an implant position in the fibula and; wherein the digital bone model is a stereolithography model of the fibula, and;
presenting the implant position in the fibula on a user interface.

20. The non transitory computer readable of claim 19 comprising instructions that, when executed by the processor cause the processor to perform the additional steps of:
segmenting digital bone model into multiple segments along its length,
determining a cross section of the fibula at each segment,
calculating a maximum length of implant possible at each segment based on the cross section and length of each segment,
identifying the segment of the fibula that can be used to position the implant based on the implant parameter and at least one of a cross-sectional area or largest cross-sectional dimension of each segment, and;
wherein the dental implant parameter may be one or more of: implant diameter, or implant cross-sectional area, or longest implant dimension or implant angle.
